(19) United States
(12) Patent Application Publication
(10) Pub. No.: US 2003/0226639 A1
(43) Pub. Date: Dec. 11, 2003

(54) Container manufacturing method

(76) Inventor: Chun-Chen Cheng, Miao Li Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/162,913

(22) Filed: Jun. 6, 2002

(51) Int. Cl. B29C 47/00; B32B 31/00

(52) U.S. Cl. 156/245; 156/267; 156/277

(57) ABSTRACT

A container manufacturing method including procedures of forming barrel body, forming outer housing and assembling. The barrel body of the container is made by blowing molding. The outer housing is made by suction molding. The outer housing is adhered on the barrel body to achieve the container with solid appearance and apparent acute angles. The material of the outer housing is previously color printed with a figure or color. After molded, the housing has a desired figure and color.

### BACKGROUND OF THE INVENTION

The present invention is related to a container manufacturing method in which the barrel body of the container is made by blowing molding, while the outer housing is made by suction molding. The outer housing is adhered on the barrel body to achieve a container with solid appearance and colorful figures and stripes.

FIG. 6 shows a conventional container made of plastic material (such as PET). The container is formed as a barrel having an interior receiving space and an opening. A liquid or solid can be contained in the receiving space. The container is mostly manufactured by way of blowing molding. A blank with an opening is blown by a blowing molding machine into a necessary shape. The barrel body of such conventional container has simple stripes without apparent acute angle. Therefore, the appearance of the container is monotonous.

Furthermore, the container made by the conventional blowing molding method has monotonous color. An outer film printed with relevant figure or trademark or company name is attached to the container to beautify the appearance of the container or highlight the trademark of the product. The outer film is attached to the container by means of contraction or adhesion and is easy to detach from the container due to external force. As a result, the indication for the container will be unclear. In addition, the outer film lacks solid visual effect and can only achieve an indication or plane visual effect. Therefore, the appearance of the container can be hardly beautified.

### SUMMARY OF THE INVENTION

It is therefore a primary object of the present invention to provide a container manufacturing method in which the barrel body of the container is made by blowing molding. The outer housing is made by suction molding. The outer housing is adhered on the barrel body to achieve a container with solid appearance and apparent acute angles.

It is a further object of the present invention to provide the above container manufacturing method in which prior to suction molding, the material of the outer housing is previously color printed with a figure or color. After molded, the outer housing has a desired figure and color so as to beautify the appearance of the container and achieve better visual effect.

The present invention can be best understood through the following description and accompanying drawings wherein:

### BRIEF DESCRIPTION OF THE DRAWINGS

FIG. 1 is a flow chart of the container manufacturing method of the present invention;

FIG. 2 shows the procedure of forming barrel body of the present invention;

FIG. 3 shows the procedure of forming outer housing of the present invention;

FIG. 4 shows the procedure of adhering the outer housing onto the barrel body of the present invention;

FIG. 5 shows a special appearance of the container manufactured by the present invention; and

FIG. 6 shows the appearance of a container manufactured by a conventional container manufacturing method.

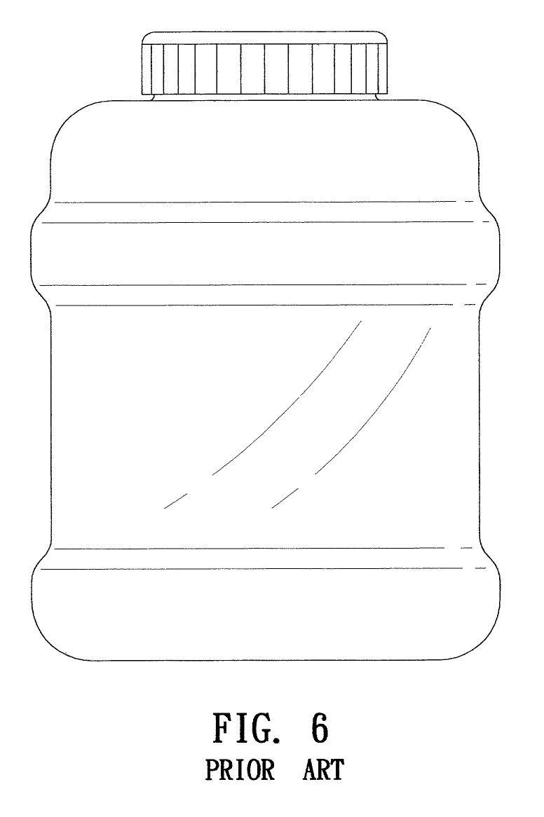

### DETAILED DESCRIPTION OF THE PREFERRED EMBODIMENTS

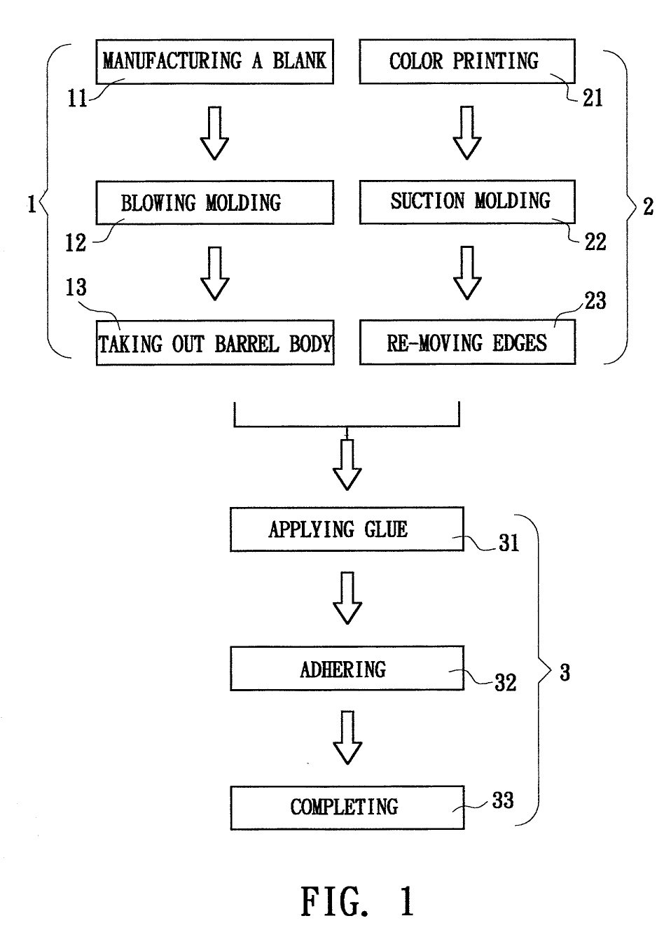

Please refer to FIG. 1. The container manufacturing method of the present invention includes procedures of forming barrel body 1, forming outer housing 2 and assembling 3.

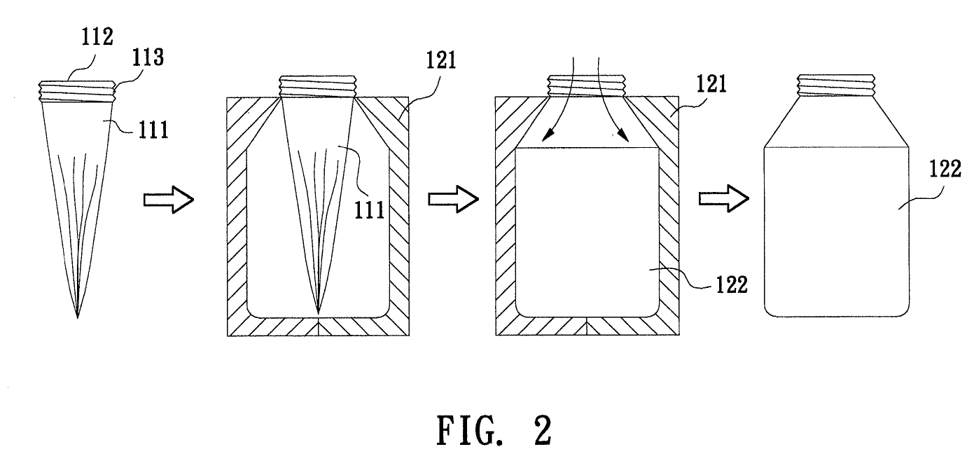

Referring to FIG. 2, the procedure of forming barrel body 1 includes the following steps:

First step of manufacturing a blank 11: A blank 111 with an opening 112 is made of a PET material. The outer side of the opening 112 is formed with an outer thread 113.

Second step of blowing molding 12: The blank 111 is placed into a blowing mold 121. A blowing molding machine (not shown) is used to blow the blank 111 into a hollow barrel body 122 with a predetermined shape. The barrel body 122 is shaped according to the mold cavity of the blowing mold 121. Therefore, by means of changing the shape of the blowing mold 121, the shape of the barrel body 122 can be changed.

Third step of taking out the barrel body 13: The blowing mold 121 is demolded to take out the barrel body 122.

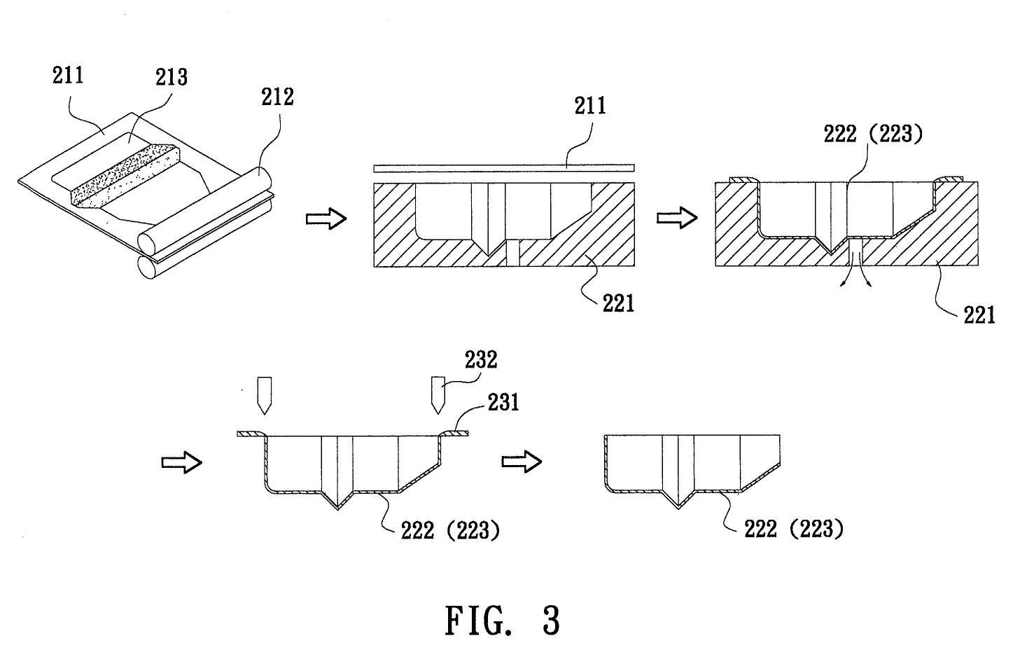

As shown in FIG. 3, the procedure of forming outer housing 2 includes the following steps:

First step of color printing 21: A halftone 212 is used to color print two PET boards 211 with a figure or color 213 on opposite portions to be molded. A deformation amount of the figure or color 213 is reserved.

Second step of suction molding 22: The two PET boards 211 color printed with the figure or color 213 are placed on a suction mold 221. A suction molding machine (not shown) is used to respectively suck the PET boards 211 into a front casing 222 and a rear casing 223 with predetermined recessed solid shape. After suction molded, the figure or color 213 is presented on the opposite portions of the front and rear casings 222, 223. The front and rear casings 222, 223 are shaped according to the shape of the mold cavity of the suction mold 221. Therefore, the shape of the suction mold 221 can be changed as necessary so as to change the shape of the front and rear casings 222, 223.

Third step of removing edges 23: After demolded, the excessive edge materials 231 of the front and rear casings 222, 223 are removed with a blade 232 to achieve the front and rear casings 222, 223. After the edge materials 231 are removed, the front and rear casings 222, 223 are to be mated with each other to form a hollow outer housing 224. The interior space of the outer housing 224 corresponds to the shape of the barrel body 122.

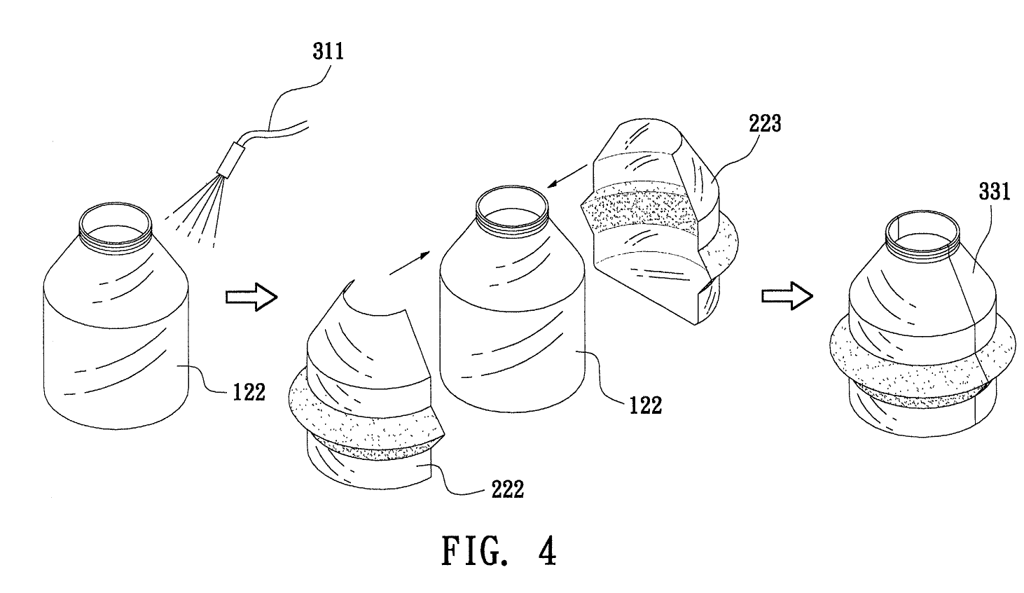

Referring to FIG. 4, the procedure of assembling 3 includes the following steps:

First step of applying glue 31: A spraying gun 311 is used to spray glue onto the outer circumference of the barrel body 122 or the inner circumferences of the front and rear casings 222, 223.

Second step of adhering 32: The front and rear casings 222, 223 are fitted and adhered onto the barrel body 122.

Third step of completing 33: After the front and rear casings 222, 223 are integrally adhered to the barrel body 122, a container product 331 with solid appearance and apparent acute angles is completed.

In the above procedures, the blank 111 is blowing molded into a barrel body 122 with simple shape without any apparent acute angle. The two PET boards 211 color printed with the figure or color 213 are suction molded into a front and a rear casings 222, 223 with solid shape and apparent acute angles. After the front and rear casings 222, 223 are integrally combined with the barrel body 122, a container product 331 with solid appearance and apparent acute angles is completed. The container 331 serves to contain therein a liquid or solid.

The housing is composed of the front and rear casings 222, 223 which are made by suction molding. By means of the characteristic of suction molding, the acute angles of the outer housing are more apparent and the appearance of the outer housing is solider. Prior to suction molding, the PET boards 211 are previously color printed with a figure or color 213. After molded, the housing has a desired figure and color so that the container product will have beautified appearance and better visual effect.

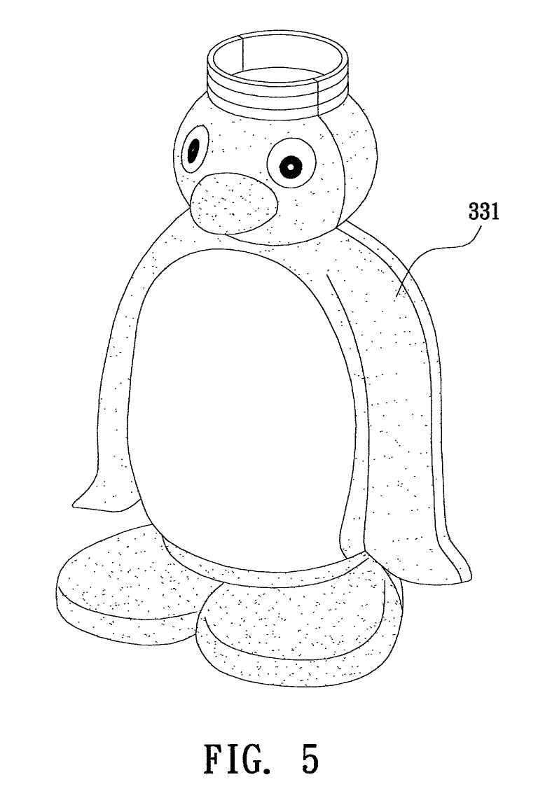

Referring to FIG. 5, the appearance of the container product 331 can be formed with multiple acute angles or special configurations. By means of changing the shape of the suction mold, the appearance of the container product 331 can be changed. Therefore, the same barrel body 131 can be assembled with different housings to achieve various patterns of containers.

The above embodiments are only used to illustrate the present invention, not intended to limit the scope thereof. Many modifications of the above embodiments can be made without departing from the spirit of the present invention.

What is claimed is:

1. A container manufacturing method comprising procedures of forming barrel body, forming outer housing and assembling, wherein:
the procedure of forming barrel body includes steps of:
manufacturing a blank, a blank with an opening being made of a plastic material;
blowing molding, the blank being placed into a blowing mold, a blowing molding machine being used to blow the blank into a hollow barrel body with a predetermined shape; and
taking out the barrel body, the blowing mold being demolded to take out the barrel body;
the procedure of forming outer housing includes steps of:
color printing, several plastic boards being color printed with a figure or color on opposite portions to be molded;
suction molding, the plastic boards color printed with the figure or color being placed on a suction mold, a suction molding machine being used to respectively suck the plastic boards into casings with predetermined recessed solid shape; and
removing edges, after demolded, the excessive edge materials of the casings being removed to achieve the casings; and
the procedure of assembling includes steps of:
applying glue, a glue being applied onto outer circumference of the barrel body or inner circumferences of the casings;
adhering, the casings being fitted and adhered onto the barrel body; and
completing, after the casings are integrally adhered to the barrel body, a container product with solid appearance and apparent acute angles being completed.

2. The container manufacturing method as claimed in claim 1, wherein the barrel body is shaped according to the shape of the mold cavity of the blowing mold, whereby the shape of the mold cavity of the blowing mold can be changed as necessary so as to change the shape of the barrel body.

3. The container manufacturing method as claimed in claim 1, wherein a deformation amount of the figure or color printed on the plastic boards is reserved.

4. The container manufacturing method as claimed in claim 1, wherein after the edge materials are removed, the casings are to be mated with each other to form a hollow complete outer housing, the shape of the interior of the outer housing corresponding to the shape of the barrel body.

5. The container manufacturing method as claimed in claim 1, wherein after suction molded, the figure or color printed on the plastic boards is presented on the opposite portions of the casings.

6. The container manufacturing method as claimed in claim 1, wherein the casings are shaped according to the shape of the mold cavity of the suction mold, whereby the shape of the mold cavity of the suction mold can be changed as necessary so as to change the shape of the casings.
